(19) United States
(12) Patent Application Publication
(10) Pub. No.: US 2018/0094839 A1
(43) Pub. Date: Apr. 5, 2018

(54) CONDENSER

(71) Applicant: MAHLE International GmbH, Stuttgart (DE)

(72) Inventors: Stefan FELBER, Schwieberdingen (DE); Christine HAAS, Bining (FR); Patrick JUNG, Rohrbach-les-Bitche (FR)

(73) Assignee: MAHLE International GmbH, Stuttgart (DE)

(21) Appl. No.: 15/833,261

(22) Filed: Dec. 6, 2017

Related U.S. Application Data
(63) Continuation of application No. PCT/EP2016/061781, filed on May 25, 2016.

(30) Foreign Application Priority Data
Jun. 29, 2015 (EP) 15174347.3

(51) Int. Cl. F25B 39/04; B23K 9/173; B23K 9/09

(52) U.S. Cl. CPC F25B 39/04; B23K 9/173; B23K 9/09; B23K 2201/14; F25B 2400/162; F28F 2220/00; F25B 2339/0441

(57) ABSTRACT

A condenser having a receiver for storing liquid refrigerant, the condenser having a heat exchanger block with at least one manifold and with a tube and fin block, wherein the tubes communicate with the at least one manifold for introducing and releasing refrigerant to or from the heat exchanger block. The receiver is located adjacent to one of the manifolds. The receiver has a tube with at least one open tube end and with at least one disc. The disc is located within the tube at the tube end in order to close the tube end and the disc is fluid tight connected with the tube end by cold metal transfer welding.

This nonprovisional application is a continuation of International Application No. PCT/EP2016/061781, which was filed on May 25, 2016, and which claims priority to European Patent Application No. 15174347.3, which was filed in Europe on Jun. 29, 2015, and which are both herein incorporated by reference.

### BACKGROUND OF THE INVENTION

### Field of the invention

The present invention relates to a condenser having a receiver for liquid refrigerant, particularly for a motor vehicle. The invention relates in addition to a motor vehicle having the condenser.

### Description of the Background Art

Condenser with an integrated receiver are known in the art as so called condenser modules. Such condenser modules have a receiver to store a defined amount of liquid refrigerant in order to compensate losses of the refrigerant in the refrigerant cycle over the life time of the condenser and additionally in order to achieve a stable sub-cooling of the refrigerant in the sub-cooling area of the condenser which is located downstream of the receiver.

Such condenser modules are known from DE 42 38 853 C2, which corresponds to U.S. Pat. No. 5,537,839, which is incorporated herein by reference.

In the conventional art condenser modules are known which have a receiver with an integrated dryer and filter assembly which is located in the receive tube of the condenser module. The receiver tube usually has two opposite open ends which are closed by a closing component such as a plug, disc or a cap. Usually one of the two ends is closed by a removable plug in order to be able to service the dryer and filter assembly by removing and exchanging the assembly. The other end of the receiver tube is usually closed by a disc which is brazed to the tube. Therefore the tube can only be opened by removing the removable plug.

Other receivers of condenser modules are closed on both ends using discs brazed to the tube such that the dryer of the receiver may not be serviced during life time of the condenser. In this case the dryer is located in the receiver tube before brazing the condenser including brazing the receiver tube. Such condenser modules are also disclosed by DE 42 38 853 C2. The brazing process is only possible for dryers which will not be removed. Otherwise a flame brazing process might be used. This flame brazing creates high temperatures inside the receiver which might destroy dryer cartridges of plastic material. Therefore flame brazing is not always possible.

Besides brazing of such discs to close the open end of a receiver tube it is known to use the laser welding process to fasten the disc to the tube and to tighten the receiver tube. Such laser welding process creates higher temperatures too and additionally the costs for such a laser welding device is quite high, such that laser welding increases the production costs of the condenser module. Therefore laser welding is only acceptable by manufacturing an annually high amount of such condenser modules.

### SUMMARY OF THE INVENTION

It is therefore an object of the present invention to provide an improved condenser having a receiver.

An exemplary embodiment provides a condenser having a receiver for storing liquid refrigerant, the condenser having a heat exchanger block with at least one manifold and with a tube and fin block, wherein the tubes communicate with the at least one manifold for introducing and releasing refrigerant to or from the heat exchanger block, wherein the receiver is located adjacent of one of the manifolds, wherein the receiver has a tube with at least one open tube end and with at least one disc, wherein the disc is located within the tube at the tube end in order to close the tube end, whereby the disc is fluid tight connected with the tube end by cold metal transfer welding. The other end of the receiver might be closed by a plug or by an additional disc. The cold metal transfer welding reduces the temperatures of the welded elements such that this process allows welding of pieces including plastic elements in their interior.

Furthermore it is an advantage that the tube of the receiver has two opposite tube ends which both are closed by a respective disc, wherein the discs are located within the tube at the respective tube end and wherein the respective disc is connected with the tube end by cold metal transfer welding. Therefore a plastic filter and dryer element might be located inside the tube of the receiver and nevertheless the receiver might be closed using two discs which are closed by cold metal transfer welding.

According to an embodiment of the invention it is an advantage that the cross section of the disc in the plane of the disc corresponds at least substantially to the cross section of the tube at the respective tube end. Accordingly it is easy to close the end of the tube of the receiver fluid tight since the gap between tube end of the wall of tube end and the disc is quite narrow. Therefore the cold metal transfer welding process allows a stable and fluid tight closing of the tube end of the receiver.

According to an embodiment of the invention, the disc can be a flat disc. Therefore the volume of the receiver tube is not strongly affected by using a flat disc as closure element.

Furthermore it is of advantage that the disc has a basically flat central portion defining a plane and a marginal portion which is bend in a direction out of the plane of the central portion. Therefore a secure and fluid tight connection between the marginal portion and the tube is possible.

According to an embodiment of the invention it is an advantage that the marginal portion is angled with respect to the central portion, wherein the angle between the marginal portion and the plane of the central portion is about 80° to 90°. Therefore the disc might be fit into the tube end by means of a sliding process or by a press fit, the secure the position of the disc inside the tube before welding.

It is furthermore an advantage that the marginal portion is located in parallel with the tube wall of an end of the tube.

A very secure fastening of disc is possible if the marginal portion of the disc is welded to the tube wall by cold metal transfer welding.

Furthermore it is an advantage that the tube of the receiver is, for example, an extruded tube, a welded tube or a deep impact extrusion tube. Therefore the tube might be made of aluminum or from an aluminum alloy or e.g. from a stainless steel material.

It is furthermore of advantage that the tube of the receiver is located in parallel or substantially parallel to a manifold of the heat exchanger block, wherein the length of the tube of the receiver is shorter or as long as the length of the manifold.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic view of a condenser with a receiver;

FIG. 2 shows a tube of a receiver in parallel with a manifold of a condenser;

FIG. 3 shows a disc for closing the end of the tube of the receiver;

FIG. 4 shows a disc inserted in the end of the tube of the receiver; and

FIG. 5 shows a sequence of pictures explaining the cold metal transfer welding process.

### DETAILED DESCRIPTION

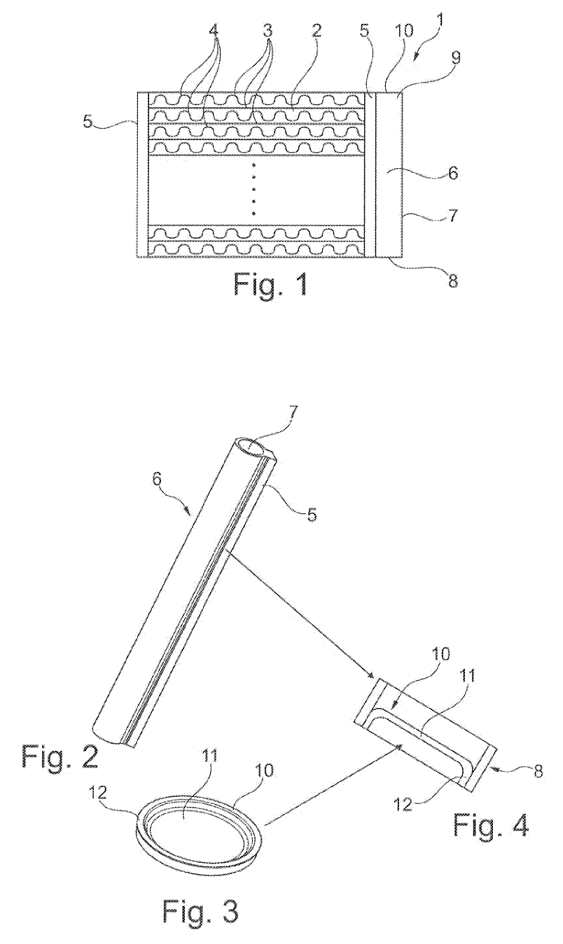

FIG. 1 shows a schematic view of a condenser 1 with a heat exchanger block 2 with tubes 3 and fins 4. The tubes 3 contain flow channels for flow of refrigerant through the tubes 3. Between two adjacent tubes 3 fins 4 are located to increase the heat exchange rate between air passing through the channels between two adjacent tubes 3 and the refrigerant passing through the tubes 3.

On both sides of the heat exchanger block 2 manifolds 5 are located. The tubes 3 of the heat exchanger block 2 are connected to the manifolds 5 to feed refrigerant from the tubes 3 to the manifolds 5 or to receive refrigerant from the manifolds 5.

Adjacent to one of the manifolds 5 a liquid receiver 6 is arranged and fluid connected to the manifold 5 to receive refrigerant from the manifold 5 and to feed refrigerant to the manifold 5. Usually between the manifold 5 and the receiver two fluid channels are arranged for flowing refrigerant to the receiver and to release refrigerant out of the receiver to the manifold.

The receiver 6 is made of a tube 7 which is closed on both tube ends 8, 9. At least one tube end 8, 9 is closed or both tube ends 8, 9 are closed by a disc 10. Maybe one tube end 8, 9 might be closed by a removable plug. Within the volume of the receiver 6 a filter and/or a dryer might be located to filter the refrigerant and to remove water particles out of the refrigerant.

FIG. 2 shows a schematic view of a receiver 6 with a tube 7 and an adjacent located manifold 5. The receiver is arranged in parallel with the manifold and the length of the tube 7 of the receiver is at least almost the length of the manifold. In other embodiments, the tube 7 of the receiver 6 might be longer or even shorter than the length of the manifold 5.

FIG. 3 shows a disc 10, which might be used to close a tube end 8, 9 of the receiver. This disc 10 might be located in the tube end 8, 9 of the tube 7 of the receiver and will be fluid tight connected to the tube 7 of the receiver 6. The disc will be connected by cold metal transfer welding to achieve a secure fastening over life time of the condenser 1 and a fluid tight fastening to close the end 8, 9 of the tube 7 of the receiver 6.

As can be seen from FIG. 3 the disc 10 has a cross section in the plane of the disc 10 which corresponds at least substantially to the cross section of the tube 7 at the respective tube end 8, 9. This leads to a more secure closing of the tube end since the gap between the disc and the tube wall at the tube end is quite small. This can be seen in FIG. 4 too.

The disc 10 has a basically flat central portion 11 defining plane and it has a marginal portion 12 which is bent in a direction out of the plane of the central portion 11. As can be seen in FIGS. 3 and 4, the marginal portion 12 is angled with respect to the central portion 11, wherein the angle between the marginal portion 12 and the plane of the central portion 11 is about 80° to 90°, and especially 90°.

According to another embodiment of the invention the disc is a flat disc.

FIG. 4 shows schematically that the disc is inserted in the tube 7 at its tube end 8. The marginal portion is located adjacent to the wall of the tube 7 at the tube end 8. At the area of the marginal portion 12 and the end 8 of the tube 7, the disc and the tube 7 are connected and the tube is fluid tight closed by cold metal transfer welding. The disc 10 is welded to the tube wall of the tube 7 of the receiver 6. As can be seen, the marginal portion 12 is located in parallel with the tube wall of a tube end 8, 9 of the tube 7. Therefore the marginal portion 12 is welded to the tube wall by cold metal transfer welding.

The tube 7 of the receiver 6 is according to one embodiment an extruded tube, a welded tube or a deep impact extrusion tube. The tube is preferably made from aluminum or an aluminum alloy or from a stainless steel.

As can be seen from FIG. 4 the tube 7 of the receiver 6 is located in parallel to a manifold 5 of the heat exchanger block 2, wherein the length of the tube 7 of the receiver 6 is shorter or as long as the length of the manifold 5.

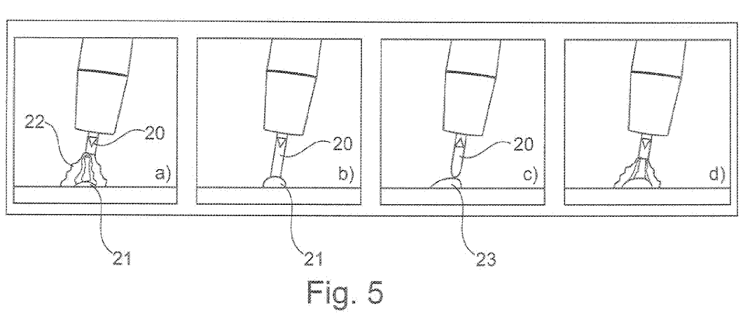

FIG. 5 shows a sequence of four drawings a) to d) to explain the cold metal transfer welding process. In a first step a) a piece welding material 20 will be moved in the direction of the welding partners which should be connected by the process. A light arc 22 is created which melts the material to be welded and creates a melting bath 21 of molten material. In case the welding material 20 hits the melting bath 21, see drawing b), the light arc 22 disappears and the welding current will be reduced by the control of the process. In the next step, please see c), the welding material 20 will be moved backwards and the creation of a material drop 23 at the elements to be welded will be supported. The welding current is still low. Since the welding material 20 no longer contacts the melting bath 21, the welding current will be increased again and a light arc is created again, see d) and the process starts again at a). During this process the energy introduced in the elements to be welded is reduced and a lower temperature of the elements to be welded is achieved.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A condenser comprising:
a receiver for storing liquid refrigerant;
a heat exchanger block with at least one manifold;
a tube; and
a fin block,
wherein the tube communicate with the at least one manifold for introducing and releasing refrigerant to or from the heat exchanger block,
wherein the receiver is arranged adjacent to one of the manifolds,
wherein the receiver has a receiver tube with at least one open tube end and with at least one disc,
wherein the disc is arranged within the receiver tube at the tube end to close the tube end, and
wherein the disc is fluid tight connected with the tube end by cold metal transfer welding.

2. The condenser according to claim 1, wherein the receiver tube of the receiver has two opposite tube ends, which both are closed by a respective disc, wherein the discs are arranged within the receiver tube at the respective tube end, and wherein the respective disc is connected with the tube end by cold metal transfer welding.

3. The condenser according to claim 1, wherein a cross section of the disc in the plane of the disc corresponds at least substantially to a cross section of the receiver tube at the respective tube end.

4. The condenser according to claim 1, wherein the disc is a flat disc.

5. The condenser according to claim 1, wherein the disc has a basically flat central portion defining a plane and a marginal portion, which is bent in a direction out of the plane of the central portion.

6. The condenser according to claim 5, wherein the marginal portion is angled with respect to the central portion, and wherein the angle between the marginal portion and the plane of the central portion is about 80° to 90°.

7. The condenser according to claim 6, wherein the marginal portion is located in parallel with the tube wall of a tube end of the receiver tube.

8. The condenser according to claim 7, wherein the marginal portion is welded to the tube wall by cold metal transfer welding.

9. The condenser according to claim 1, wherein the receiver tube of the receiver is an extruded tube, a welded tube or a deep impact extrusion tube.

10. The condenser according to claim 1, wherein the receiver tube of the receiver is located in parallel to a manifold of the heat exchanger block, wherein a length of the receiver tube of the receiver is shorter or as long as a length of the manifold.
